(19) United States
(12) Patent Application Publication
(10) Pub. No.: US 2008/0134856 A1
(43) Pub. Date: Jun. 12, 2008

(54) Card cutter

(75) Inventor: Hitoshi Kawachi, Tokyo (JP)

Correspondence Address: OLIFF & BERRIDGE, PLC, P.O. BOX 320850, ALEXANDRIA, VA, 22320-4850, US

(73) Assignee: CARL MANUFACTURING CO., LTD., TOKYO (JP)

(21) Appl. No.: 12/000,278

(22) Filed: Dec. 11, 2007

(30) Foreign Application Priority Data
Dec. 12, 2006 (JP) 2006-334459

(51) Int. Cl. B26D 7/06; B26D 7/00

(52) U.S. Cl. 83/436.6; 83/436.3

(57) ABSTRACT

A card cutter for producing a plurality of cards by cutting a sheet is provided, wherein a pair of rotary shafts rotating in directions opposite to each other are provided with a sheet feeding path between them. A plurality of first rotary blades are arranged on the one rotary shaft, while a plurality of second rotary blades are arranged on the other rotary shaft so that they slide in contact with each other between the peripheral edges so as to constitute a slitter cutting portion. A roller for pressing each end of the sheet outside the slitter cutting portion is provided at least at the one rotary shaft.

### TECHNICAL FIELD

The present invention relates to a card cutter for producing a plurality of cards by cutting a sheet.

### BACKGROUND ART

Demands regarding name card forms have become more diversified recently, and with this trend, design of name cards has become complicated and delivery schedules are becoming tighter. As a part of such trends, a card cutter has been provided so that a user can produce a name card by himself/herself (See Patent Document 1, 2, for example). In many types of such card cutters, first, a portion corresponding to a plurality of name cards is printed or printed out on a single sheet using a printer and then, using a card cutter, the prepared sheet is cut laterally and longitudinally so as to produce a plurality of name cards. For example, a card cutter A shown in FIG. 5 is provided with a lateral cutting portion 11, and by relatively moving a pair of upper and lower cutting blades 11a, 11b vertically, a sheet 2 is cut in a lateral direction crossing the feeding direction. Moreover, the card cutter A is provided with a vertical cutting portion 15, and by rotating a pair of upper and lower rotary blades 21, 24 in opposite directions in sliding contact, the sheet 2 is cut in the longitudinal direction along the feeding direction. Furthermore, as shown in FIG. 6, each lateral cutting line 35 and each longitudinal cutting line 36 of the sheet 2 are cut so as to produce a plurality of name cards 31. The card cutter A shown in FIG. 5 is the same as the one disclosed in FIG. 1 of Patent Document 1. The applicant of Patent Document 1 is the same as the applicant of the present invention, and the contents disclosed in Patent Document 1 are incorporated herein by reference.

The above example of the related art is a configuration suitable for production of a plurality of name cards 31 by cutting the sheet 2 laterally and longitudinally. However, a spot surrounded by a circle in FIG. 6, that is, on the side portion of the name card 31 after cutting and at a corner in the rear of the feeding direction, an outwardly projecting horn X might be generated. Particularly, in the case of single-cut in which the name cards 31 are directly adjacent to each other in the longitudinal direction shown in FIG. 6, there is a tendency that the horn X is generated at a rear corner of the name card 31 on the outermost part. Alternatively, as shown in FIG. 7, in double-cut in which a gap is provided between the name cards 31 adjacent to each other in the longitudinal direction, there is a tendency that the horn X is generated at a rear corner of each name card 31. FIGS. 6 and 7 illustrate the horn X in an exaggerated manner for simplification of explanation, but the size of the horn X is much finer in reality. Thus, post-treatment takes time and the post-treatment is omitted in many cases. However, particularly when the name card 31 is to be produced, considering that the name card 31 is a tool to show a social position of its owner, production of the name card 31 in a more complete form has been requested. However, incorporation of further mechanisms, controls or the like in the card cutter A for such post-treatment complicates the configuration of the card cutter A and increases its cost, which is a serious problem.

Patent Document 1: Japanese Unexamined Patent Application Publication No. 2005-34962

Patent Document 2: Japanese Unexamined Patent Application Publication No. H0-146796

### DISCLOSURE OF THE INVENTION

### Problems to be Solved by the Invention

The present invention was made in view of the above example of the related art and has an object to provide a card cutter for producing a name card in a more complete form without incorporating complicated mechanisms, controls or the like.

### Means for Solving the Problems

The above object can be achieved by the invention described in claims appended to the present specification.

(1) That is, in the present invention, a card cutter for producing a plurality of cards by cutting a sheet is most distinctively characterized by:

a pair of rotary shafts rotating in directions opposite to each others with a feeding path supplying the sheet between them and having an axial direction extending in a direction crossing the feeding direction;

a plurality of first rotary blades arranged with a predetermined interval in the axial direction of one rotary shaft of the pair of rotary shafts;

a plurality of second rotary blades arranged in the axial direction of the other rotary shaft of the pair of rotary shafts and constituting a slitter cutting portion with peripheral edges in sliding contact with peripheral edges of the first rotary blades; and

a roller for pressing each end of the sheet outside the slitter cutting portion when the sheet is cut by the slitter cutting portion provided at least at one of the rotary shafts.

### (2) Moreover, in a preferred embodiment of the present invention, the roller for pressing the end of the sheet outside the slitter cutting portion is constructed by an elastic member.

(3) Furthermore, in a preferred embodiment of the present invention, the first rotary blades are thick blades, and their peripheral edges are brought into sliding contact with peripheral edges of the second rotary blades inside the axial direction of one of the rotary shafts and cylindrical shaped faces are brought into sliding contact with the roller outside the axial direction of one of the rotary shafts so as to sandwich the end of the sheet between them.

### ADVANTAGES

The card cutter of the present invention is basically configured as above, and in particular, the following advantages are achieved.

(1) That is, since the respective ends of the sheet are held outside the slitter cutting portion in the present invention, by holding the outer end on both sides of the sheet, a predetermined tension can be exerted over the entire width direction of the sheet at cutting. By this arrangement, no slackness is generated at the end of the sheet, and generation of a horn, which has been a problem, can be prevented.

Moreover, since the surface of the sheet can be pressed into contact with a constant pressure from the cylindrical shaped face of the roller, it is suitable for exertion of a predetermined tension on the sheet at cutting. Also, since the configuration of rolled support of the sheet being fed can be realized only by mounting the roller on the rotary shaft, application to an existing card cutter is facilitated.

### (2) Moreover, when an elastic member is used for the roller, a pressing force applied on the sheet can be further increased.

(3) Furthermore, when a second sheet pressing portion is configured using an existing first rotary blade, it is only necessary to add a new roller only to one of the rotary shafts, and the number of parts can be minimized. Also, since the sheet is sandwiched using the circumferential face of the first rotary blade, displacement of the sheet can be prevented by pressing the end of the sheet in proximity to the cutting line in the longitudinal direction. Also, existing equipment can be effectively utilized with little change of the internal configuration of a conventional card cutter.

Further advantages of the card cutter of the present invention will be made clear from the description below or the attached drawings.

### BRIEF DESCRIPTION OF THE DRAWINGS

FIG. 1 is a diagram illustrating a slit cutting portion of a card cutter according to the present invention;

FIG. 2 is a diagram illustrating a peripheral portion of a first rotary blade and a second rotary blade on the right end portion side shown in FIG. 1 in an enlarged manner;

FIG. 3 is an exploded perspective view of a peripheral portion of a sub assembly supporting the second rotary blade on the right end portion side shown in FIG. 1;

FIG. 4 is a diagram illustrating a second sheet pressing portion of another embodiment, though resembling FIG. 2;

FIG. 5 is a sectional view illustrating an example of the card cutter;

FIG. 6 is a view illustrating a printed or printed-out state of a card sheet; and

FIG. 7 is a view illustrating another printed or printed-out state of a card sheet.

### BEST MODE FOR CARRYING OUT THE INVENTION

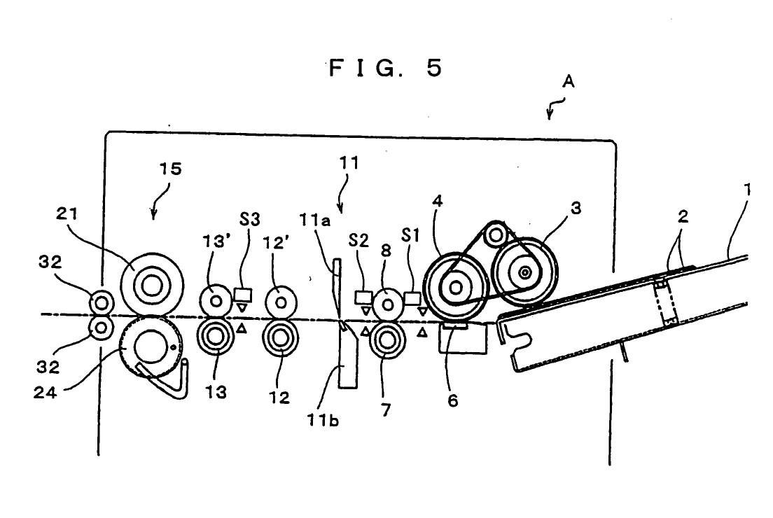

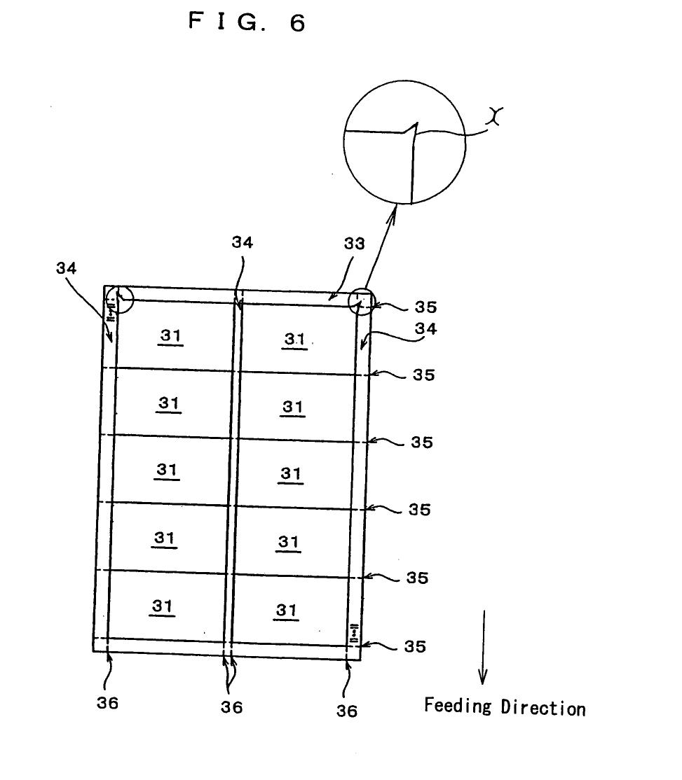

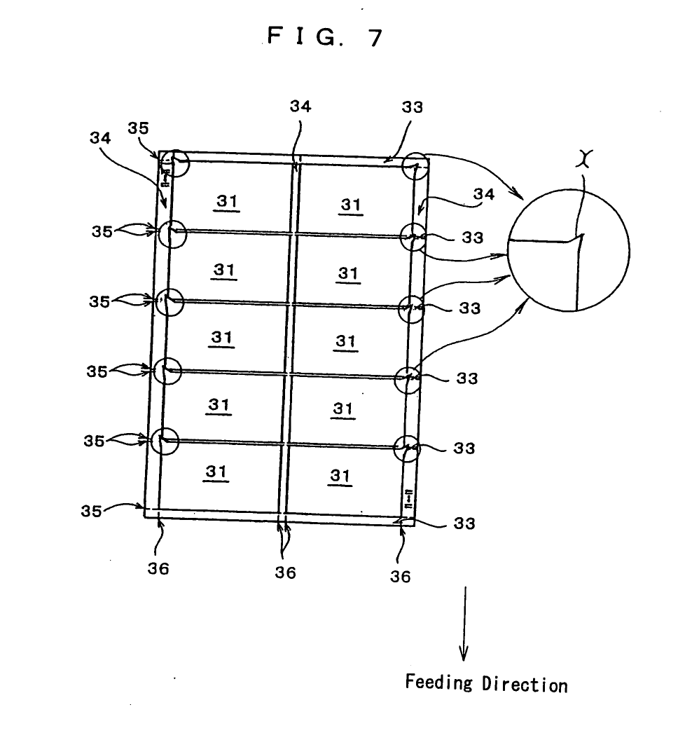

First, referring to FIG. 5, again, an entire outline of a card cutter A disclosed in Patent Document 1 incorporated in the present invention will be described. The card cutter A has a paper feeding base 1 on an inlet side of a main body, from which a sheet 2 is supplied into the card cutter A. Inside the main body, a feeding path for guiding the sheet 2 along a predetermined path is provided as shown by a one-dot broken line. Moreover, a cutting portion 11 is provided for laterally cutting the sheet 2 fed along this feeding path at least at two or more plural locations. Also, a cutting portion 15 is provided for longitudinally cutting the sheet 2 fed along the feeding path at least at two or more plural locations. By these cutting portions 11, 15, each lateral cutting line 35 and each longitudinal cutting line 36 of the sheet 2 are cut as shown by FIGS. 6, 7 so as to produce a plurality of cards 31. In the illustrated embodiment, the sheet 2 is cut in the order of the lateral direction and then, the longitudinal direction, but it is possible to cut the sheet 2 in the order of the longitudinal direction and then, the lateral direction in another embodiment. Also, in the embodiment shown in FIG. 5, the single cutting portion 11 is used to perform sequential cutting in the lateral direction one by one, but it is possible to carry out cutting in the lateral direction at two or plural locations at the same time using two or plural cutting portions 11.

In the present invention, arbitrary types of cards can be produced, and for example, various types of cards including name cards, various membership cards, patient's registration cards of a hospital and the like can be produced. As a specific example, a case of producing a name card will be described. Usually, contents of a plurality of name cards 31 are printed or printed out in advance on the surface of the sheet 2. For example, as shown in FIGS. 6, 7, ten name cards 31 in total arranged in two columns by five rows are printed or printed out on the surface of the sheet 2. Recycled paper can be used for the sheet 2, but paper made from non-wood or those from still other materials may be also used.

The sheet 2 prepared as above is fed into the main body of the card cutter A from the paper feeding base 1, but for example, the sheets 2 stacked in plural and placed on the paper feeding base 1 are taken up one by one by a pick-up roller 3 arranged on the downstream side of the paper feeding base 1 and fed to a paper feeding roller 4. The paper feeding roller 4 is disposed in a state in pressure contact with a double-feeding preventive pad 6, and if the sheets 2 fed by the paper feeding roller 4 are erroneously double-fed, the double-feeding can be prevented by a difference in friction force between the paper feeding roller 4 and the double-feeding preventive pad 6. Only a single piece of the sheet 2 is assuredly fed by the paper feeding roller 4 to between a first feeding roller 7 and a first feeding and pressure roller 8 arranged on the downstream side. A first detection sensor S1 may be disposed between the paper feeding roller 4 and the first feeding roller 7 so as to detect if the side end portion of the sheet 2 fed by the paper feeding roller 4 is displaced or not from the feeding direction by a predetermined amount or more. In the illustrated embodiment, the plurality of sheets 2 are supplied into the card cutter using the paper feeding base 1, but a paper feed cassette in which a plurality of sheets are stacked may be used instead of the paper feeding table 1.

In order to control feeding by the first feeding roller 7 and the first feeding and pressure roller 8, a sensor may be incorporated in this feeding path. For example, a second sensor S2 may be disposed on the downstream side of the first feeding roller 7 and the first feeding and pressure roller 8 to detect the distal end portion of the sheet 2 so that the sheet 2 is intermittently fed into the lateral cutting portion 11 for a preset feeding amount. The lateral cutting portion 11 cuts the sheet 2 fed along the feeding path at least at two or more plural locations in the lateral direction. The cutting portion 11 includes a pair of upper and lower cutting blades 11a, 11b, for example, and the sheet 2 intermittently fed by the first feeding roller 7 is cut by the pair of upper and lower cutting blades 11a, 11b in the lateral direction crossing the feeding direction in synchronization with the intermittent driving control of the first feeding roller 7. The pair of upper and lower cutting blades 11a, 11b are configured so that one of the cutting blades is vertically moved with respect to the other cutting blade, while the other cutting blade is fixed.

The lateral cutting will be described in detail by referring to FIGS. 6, 7, again. The sheet 2 on which a plurality of card portions 31 are printed or printed out is positioned by intermittent feeding by the first feeding roller 7 so that the lateral cutting line 35 shown in FIGS. 6, 7 comes to the cutting position of the pair of upper and lower cutting blades 11a, 11b disposed in the above-mentioned lateral cutting portion 11. After the cutting position is positioned, cutting is performed by the pair of upper and lower cutting blades 11a, 11b along the lateral cutting line 35 shown in FIGS. 6, 7. After the cutting, the intermittent feeding is carried out for positioning by the first feeding roller 7 so that the subsequent lateral cutting line 35 comes to the cutting position of the pair of upper and lower blades, and cutting by the pair of upper and lower cutting blades 11a, 11b is performed sequentially. The sheet 2 first fed into the lateral cutting portion 11 by intermittent cutting by the first feeding roller 7 has its margin 33 on the distal end portion side cut along the lateral cutting line 35, and the margin 33 is dropped and stored in a margin box, not shown, disposed below the lateral cutting portion 11. The sheet 2 whose margin 33 is cut away is given the subsequent intermittent feeding by the first feeding roller 7 and fed while being sandwiched between second feeding rollers 12, 12′. When the subsequent lateral cutting line 35 is positioned at the cutting position of the pair of upper and lower cutting blades 11a, 11b, the feeding of the first feeding roller 7 and the second feeding roller 12 is stopped, and cutting is performed along the lateral cutting line 35. A card portion of the sheet 2 cut away and separated is fed to a third feeding roller 13 by the second feeding roller 12. The sheet 2 remaining after cutting of the separated card portion is intermittently fed and positioned by the first feeding roller 7 so that the subsequent lateral cutting line 35 comes to the cutting position of the pair of upper and lower cutting blades 11a, 11b. As shown in FIG. 7, if the margin 33 in the front and rear direction is present between the current card and the subsequent card, when the cutting of the margin 33 is performed in the front and rear direction at the subsequent cutting, the cut-away longitudinal margin 33 is dropped and stored in the margin box, not shown.

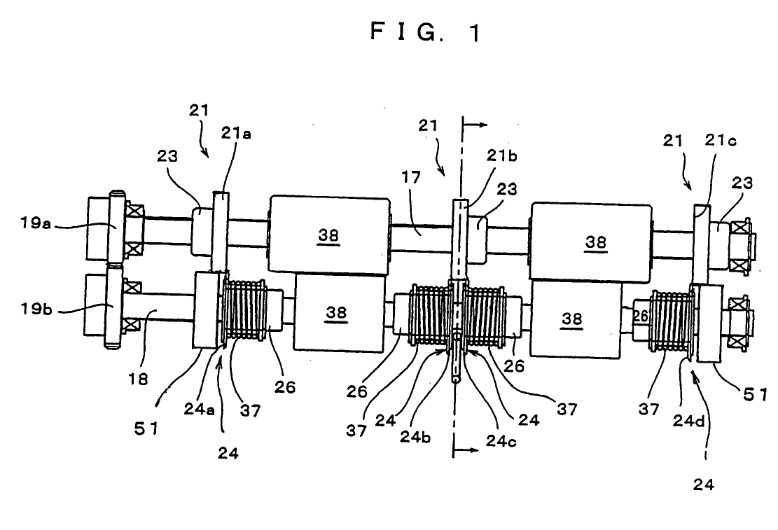

Referring to FIG. 5, again, in order to control feeding by the third feeding roller 13 and a third pressure roller 13′ for feeding, a sensor can be incorporated in this feeding path. For example, a third sensor S3 may be disposed on the downstream side of the second feeding roller 12 and the second pressure roller 121 for feeding to detect the distal end portion of the sheet 2 so that the sheet 2 cut in the lateral direction is intermittently fed into a slitter cutting portion 15 for longitudinal cutting for a preset feeding amount. In the slitter cutting portion 15, a plurality of first rotary blades 21 and second rotary blades 24 rotating in opposite directions with the feeding path between them as shown in FIG. 5 are disposed in a number corresponding to that of longitudinal cutting lines 36 (See FIGS. 6, 7) to be cut. Next, referring to FIG. 1, the slitter cutting portion 15 according to the present invention will be described in detail. A sectional view along a central chain line in FIG. 1 corresponds to FIG. 5.

In order to configure the slitter cutting portion 15, as shown in FIG. 1, a first rotary shaft 17 and a second rotary shaft 18 are pivotally supported from both their end portion sides rotatably. At least either one of the ends is driven by a motor and is connected so as to receive power from an output shaft of the motor. At this time, in order to control the rotation number of the output shaft of the motor, an arbitrary reducer mechanism may be interposed. At the ends of the first rotary shaft 17 and the second rotary shaft 18 on the opposite side, gears 19a, 19b are mounted so as to be meshed in a pair, for example. They are spur gears or helical gears, for example, and rotate and drive one of the rotary shafts by the motor and rotate and drive the other rotary shaft in the opposite direction at the same time. Moreover, another gear may be mounted to the gears 19a, 19b so as to rotate and drive another rotary shaft at the same time. Each of the first rotary blades 21 is mounted on the first rotary shaft 17 and arranged at a position corresponding to the longitudinal cutting line 36 to be cut. Also, the second rotary blade 24 is mounted on the second rotary shaft 18 and disposed to slide in contact with the first rotary blade 12 at their peripheral edges for cutting along the longitudinal cutting line 36 between that and the first rotary blade 21.

In the embodiment shown in FIG. 1, the first rotary blades 21 are formed as three thick blades 21a to 21c, for example, and each of them is mounted so as to rotate integrally with the first rotary shaft 17 through a boss 23. The second rotary blades 24 are formed as four thin blades 24a to 24d, for example, and each of them is mounted to rotate integrally with the second rotary shaft 18 through a boss 26. Each of the second rotary blades 24 is urged in the axial direction toward the first rotary blade 21 using an elastic body 37 and its peripheral edge is brought into sliding contact with the peripheral edge of the first rotary blade 21. In this case, the name cards 31 are formed in two columns (See FIGS. 6, 7). However, in another embodiment, the first rotary blades 21 and the second rotary blades 24 may be provided in different numbers so as to form a plurality of name cards 31 in a different mode. Since the first rotary blades 21 are thick blades, the surface of the sheet 2 can be brought into pressure contact from the cylindrical shaped face at the cutting. This thickness can be varied according to the embodiment.

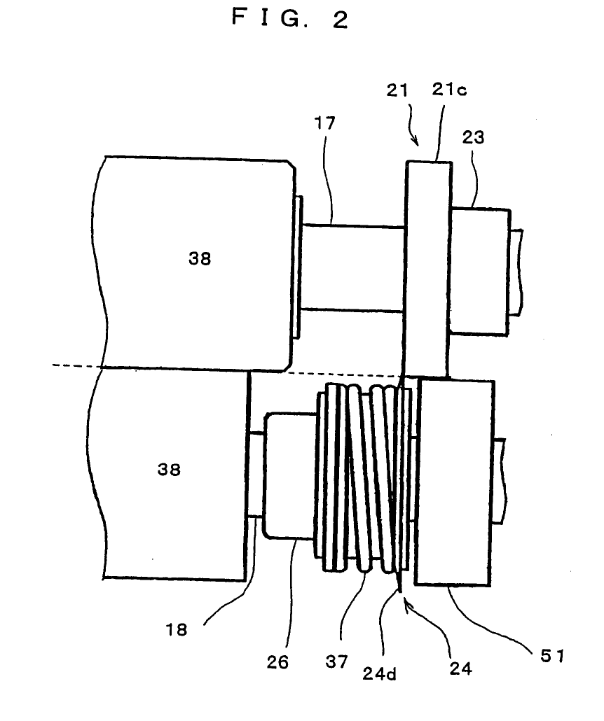

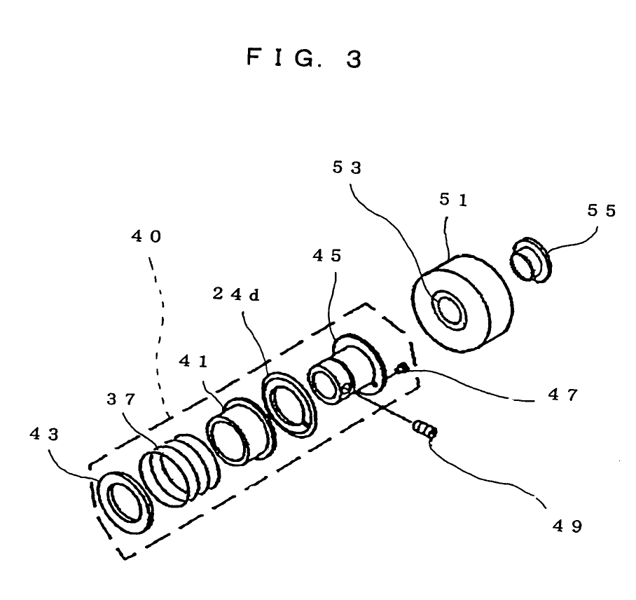

Referring to FIG. 2, the peripheral portions of the first rotary blade 21c and the second rotary blade 24d on the right end portion side shown in FIG. 1 are shown in an enlarged manner. Referring to FIG. 3, a sub assembly 40 supporting the second rotary blade 24d is exemplified. In the form illustrated in FIG. 3, the elastic body 37 urging the second rotary blade 24d is a helical spring and mounted on a peripheral face of a cylindrical spring holder 41. One of the ends of the spring 37 is fixed by a holder spacer 43, while the other end is engaged with a circular edge portion of the spring holder 41. The circular edge portion of the spring holder 41 is brought into contact with the side face of the second rotary blade 24d from the opposite side. Moreover, a thin-blade holder 45 is arranged on the side face on the opposite side of the second rotary blade 24d. The thin-blade holder 45 has a cylindrical main body and is fitted inside the spring holder 41. The second rotary blade 24d is sandwiched between the spring holder 41 and the thin-blade holder 45. On the thin-blade holder 45, a pin 47, a screw 49 or the like may be mounted. By configuring the sub assembly 40 as above, the peripheral edges of the first rotary blade 21c and the second rotary blade 24d slide in contact with each other by an urging force of the spring 37 as shown in FIG. 2.

Referring to FIGS. 1 and 6, 7, right and left margins 34 are cut by the single-edged thick blade 21a of the first rotary blade 21 and thin blade 24a of the second rotary blade 24 as well as the single-edged thick blade 21c of the first rotary blade 21 and the thin blade 24d of the second rotary blade 24, and the margins 34 between the cards are cut by the double-edged thick blade 21b of the first rotary blade 21 and the thin blades 24b, 24c of the second rotary blade 24 in sliding contact with the blade edges on both sides, respectively. When this cutting is performed, between each slitter cutting portion made of the first rotary blade 21 and the second rotary blade 24 is provided a first sheet pressing portion 38 also working as a feeding roller. Specifically, a pair of wide rollers 38 are disposed between the first rotary blades 21a and 21b and between 21b and 21c on the first rotary shaft 17, and in correspondence with them, a pair of wide rollers 38 are disposed between the second rotary blades 24a and 24b and between 24c and 24d on the second rotary shaft 18. The roller 38 on the first rotary shaft 17 and the roller 38 on the second rotary shaft 18 are opposed to each other vertically, and the sheet 2 is passed between them at the cutting to be surely supported and fed.

Referring to FIG. 2, a state is shown where the sheet 2 is fed while being sandwiched between the upper and lower rollers 38, 38 along a line shown by a dotted line. Moreover, skewing or the like is also prevented by the rollers 38, 38. Each roller 38 is formed into a cylindrical shape so as to support the sheet by a peripheral face with a high friction coefficient and also to exert a tension evenly on the surface of the sheet 2 at cutting. Thus, the sheet 2 can be fed while slackness is prevented.

However, the advantage of the first sheet pressing portion 38 is limited between the slitter cutting portions made of the first rotary blades 21 and the second rotary blades 24, or more specifically, limited between the first rotary blade 21a and the first rotary blade 21b, and between the first rotary blade 21b and the first rotary blade 21c, and a sufficient tension is not exerted to outside the first rotary blade 21a, first rotary blade 21c on right and left both end sides. Thus, in the related art, as shown by a spot surrounded by a circle in FIGS. 6, 7, the horn X is generated at the corner of the name card 31 after being cut. Then, in this embodiment, as mentioned above, the first sheet pressing portion 38 for pressing the end of the sheet 2 between each slitter cutting portions is provided and moreover, a second sheet pressing portion 51 for pressing the end of the sheet 2 outside the slitter cutting portion is provided. Furthermore, by transmitting a sufficient tension also to the end of the sheet 2 at cutting by the second sheet pressing portion 51, the sheet 2 is evenly supported in the width direction and slackness of the whole is prevented. As a result, the present invention can cut the finally obtained name card 31 into an extremely accurate rectangle and prevent generation of the horn X at the corner unlike the related art shown in FIGS. 6, 7, and product quality is markedly improved. The finally obtained name card 31 is discharged from a pair of discharge rollers 32 shown in FIG. 5.

Preferably, the second sheet pressing portion 51 is configured to be rotated with the rotary shaft 18 and presses the sheet 2 smoothly. Specifically, the second sheet pressing portion 51 is a roller and mounted on the end portion side of at least one of the rotary shafts 17, 18. Referring to FIG. 2, the roller 51 is formed into a cylindrical shape with a flush peripheral face and evenly exerts a tension on the surface of the sheet 2 at cutting. In particular, if the first sheet pressing portion 38 and the second sheet pressing portion 51 are formed into a cylindrical shape with the same diameter, the sheet 2 is evenly sandwiched in the width direction from end to end along the line shown in FIG. 2 by a dotted line, and the surface of the name card 31 is assured to be made horizontal. However, one of the second sheet pressing portions 51 is not limited to the form of a pressure roller rotating with the rotary shaft 18 but may be configured using a leaf spring or the like so as to support the end of the sheet 2 elastically.

More preferably, as shown in FIG. 2, the roller 51 is arranged so as to oppose the first rotary blade 21c only on the end portion side of the second rotary shaft 18 and to hold the end of the sheet 2 between the first rotary blade 21c and the roller 51 as indicated by the dotted line. That is, the first rotary blade 21c is the thick blade 21c and performs slitter cutting in sliding contact between the peripheral edges with the second rotary blade 24d on one end portion side (inside the axial direction of the rotary shaft 17), and moreover, on the other end portion side (outside the axial direction of the rotary shaft 17), the cylindrically shaped faces are brought into sliding contact with the roller 51 so as to sandwich the end of the sheet 2 between them. In this case, the roller 51 is newly arranged using the existing thick blade 21c on the rotary shaft 17, instead of arrangement of the pair of rollers 51, 51 on the both rotary shafts 17, 18, and the number of parts can be minimized. The overlapping extent of the roller 51 and the thick blade 21c may be enough if the end of the sheet 2 can be held and they are overlapped by 3 mm or more, for example. However, it is possible to place the rollers 51, 51 opposite each other on both end portion sides of the first rotary shaft 17 and the second rotary shaft 18 so as to sandwich the end of the sheet 2 between the rollers 51. This is effective particularly when the width of the end of the sheet 2 is large and it is desirable to hold the end of the sheet 2 over a sufficient length, for example. In this case, the outer diameter of the boss 23 holding the first rotary blade 21c from outside may be expanded so as to be used as the second sheet pressing portion 51, for example.

A material of one of the rollers 51 constituting the second sheet pressing portion is preferably different from the material of the other roller 51 working as a pair. In the embodiment shown in FIG. 2, the end of the sheet 2 is sandwiched between the cylindrical shaped faces of the first rotary blade 21c and the roller 51, but the materials of the two are different from each other. For example, the material of the first rotary blade 21c is steel (cold-rolled die steel or a similar material), while the material of the roller 51 is a material that has elasticity such as rubber, elastomer, synthetic resin and the like so as to improve pressing force onto the first rotary blade 21c. This combination is excellent in abrasion resistance, impact resistance and vibration absorption, and a desired effect can be expected as the sheet pressing portion 51.

Referring to FIG. 3, a circular hole 53 for mounting is provided at a center part in the main body of the roller 51 so as to enable fixation onto the second rotary shaft 18. The mounting method of the roller 51 may be varied, but the inner face of the hole 53 may be flush so that the roller 51 can be slid to a predetermined position on the second rotary shaft 18, for example. At this time, a reduced diameter portion may be provided on the end portion side of the second rotary shaft is and a reduced diameter portion may be provided on the inner diameter of the hole 53 in the roller 51 in correspondence with this diameter change so that the roller 51 can be easily positioned at a predetermined position of the second rotary shaft 18. Alternatively, the roller 51 can be positioned at a predetermined position on the second rotary shaft 18 using a key. Moreover, it is possible to fix the roller 51 on the end portion side of the second rotary shaft 18 by providing a female screw thread on the inner face of the hole 53 in the roller 51 and a corresponding male screw thread on the outer face of the second rotary shaft 18 and by screwing the roller 51 on the second rotary shaft 18. The roller 51 may be mounted by any other arbitrary means. Referring to FIG. 3, a holder 55 is further provided outside the roller 51 so as to hold the roller 51 on the second rotary shaft 18 to ensure that the roller 51 is rotated at a predetermined position integrally with the rotary shaft 18 all the time.

In a preferred embodiment, as shown in FIG. 2, the roller 51 is formed in a cylindrical shape, and the peripheral face is made flush, to which the surface of the sheet 2 is evenly pressed into contact. Only by mounting the roller 51 to the rotary shaft as above, the sheet being fed while being cut can be pressed and held at the end, and slackness at the sheet end portion at cutting can be prevented. By this arrangement, displacement of the cutting line in the rear in the feeding direction caused by slackness in the sheet during the cutting process can be prevented, and generation of the horn X can be prevented. Also, since the roller 51 can be mounted on the second rotary shaft 18 relatively easily, assembling performance at manufacture and maintenance is excellent. Since the roller 51 is added without little change in the internal configuration of the conventional card cutter A, existing equipment can be utilized. Particularly, when the second sheet pressing portion is configured by providing the roller 51 opposite the thick blade 21c, a component to be newly added and a space required in configuration can be minimized, which can contribute to reduction in size of the card cutter A. Moreover, with the above configuration, the card cutter A for producing a name card in a perfect form can be provided without incorporating complicated mechanisms or controls. With this configuration, there is no noise generation, which contributes to silence of the card cutter A. Therefore, the present invention is extremely excellent in practice.

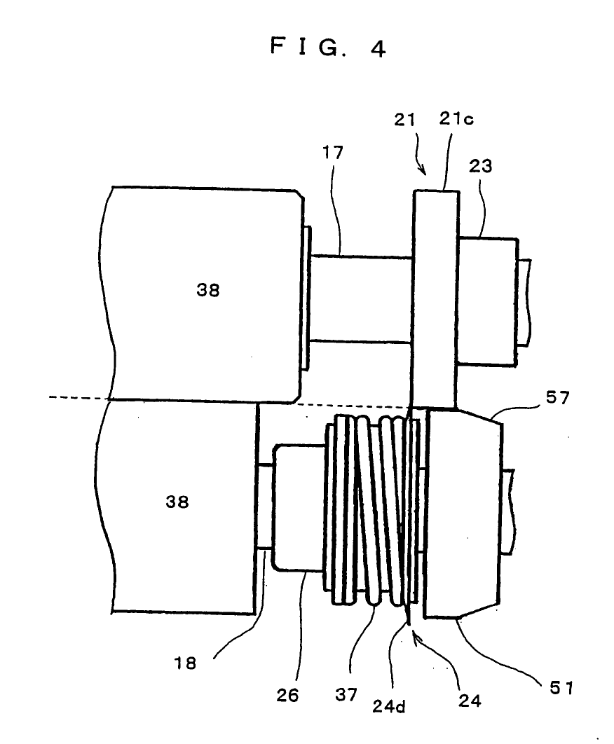

The card cutter A according to the preferred embodiment of the present invention has been described using the attached drawings, but the drawings are exemplified for the embodiment of the present invention and not intended to limit the scope of the present invention. For example, the second sheet pressing portion 51 is formed into a cylindrical shape and presses the end of the sheet 2 from the peripheral face in contact, but the peripheral face does not have to be flush but the outer diameter is changed and a groove to let the end of the sheet 2 go outside after cutting may be provided. For example, as shown in FIG. 4, the second sheet pressing portion 51 may be formed into a conical shape so that the end of the sheet 2 after cutting can escape to the outside easily by using its inclined face 57. In this case, the second sheet pressing portion 51 can have a function of rapidly recovering the end of the cut-out sheet 2 in addition to the function of pressing the end of the sheet 2 in contact at cutting. The end of the sheet 2 after cutting is dropped and stored in a margin box, not shown, arranged below the longitudinal cutting portion 15. FIG. 4 is an outline view in order to facilitate explanation, and the inclination angle and length of the inclined face 57 is determined as appropriate according to the embodiment.

Moreover, in another embodiment of the present invention, the card cutter A may be configured so that the sheet 2 is cut only in the feeding direction. In this case, the present invention can be also applied to a structure for producing a band-like card, for example.

Furthermore, in another embodiment of the present invention, the first sheet pressing portion 38 may be omitted. In this state, the present invention can be applied to a case where a sufficient tension can be applied to the sheet 2 in the right and left width direction by pressing the right and left ends of the sheet 2 by the second sheet pressing portion 51.

Furthermore, in another embodiment of the present invention, a roller for pressing the sheet may be provided on one of the rotary shafts to be rolled and pressed onto a mounting base on which the end of the sheet 2 during feeding is mounted. This roller may use the thick blade 21.

Furthermore, in still another embodiment according to the present invention, instead of sandwiching the sheet 2 between the thick blade 21 and the roller 51 for pressing the sheet, a roller for pressing the sheet may be mounted on the rotary shaft separately from the thick blade 21.

It is possible to apply various modifications or the like to the present invention in the scope of the appended claims.

1. A card cutter for producing a plurality of cards by cutting a sheet, comprising:
a pair of rotary shafts rotating in directions opposite to each other with a feeding path supplying the sheet between them and having an axial direction extending in a direction crossing the feeding direction;
a plurality of first rotary blades arranged with a predetermined interval in the axial direction of one rotary shaft in said pair of rotary shafts;
a plurality of second rotary blades arranged in the axial direction of the other rotary shaft in said pair of rotary shafts and constituting a slitter cutting portion with the peripheral edges sliding in contact with peripheral edges of said first rotary blades; and
a roller for pressing each end of the sheet outside said slitter cutting portion when the sheet is cut by said slitter cutting portion provided at least at one of said rotary shafts.

2. The card cutter according to claim 1, wherein said roller for pressing the end of the sheet outside said slitter cutting portion is constructed by an elastic member.

3. The card cutter according to claim 1, wherein, said first rotary blades are thick blades, and the peripheral edges are brought into sliding contact with the peripheral edges of said second rotary blades inside the axial direction of said one of the rotary shafts and cylindrical shaped faces are brought into sliding contact with said roller outside the axial direction of said one of the rotary shafts so as to sandwich the end of the sheet between them.

4. The card cutter according to claim 2, wherein, said first rotary blades are thick blades, and the peripheral edges are brought into sliding contact with the peripheral edges of said second rotary blades inside the axial direction of said one of the rotary shafts and cylindrical shaped faces are brought into sliding contact with said roller outside the axial direction of said one of the rotary shafts so as to sandwich the end of the sheet between them.
